(19) United States
(12) Patent Application Publication
(10) Pub. No.: US 2010/0271998 A1
(43) Pub. Date: Oct. 28, 2010

(54) Terminal Apparatus and Sleep Method of Wireless System

(75) Inventors: Lei Jin, Shenzhen (CN); Xuyong Wu, Shenzhen (CN); Juejun Liu, Shezhen (CN)

Correspondence Address: Slater & Matsil, L.L.P., 17950 Preston Road, Suite 1000, Dallas, TX, 75252, US

(73) Assignee: HUAWEI TECHNOLOGIES CO., LTD., Shenzhen (CN)

(21) Appl. No.: 12/831,568

(22) Filed: Jul. 7, 2010

Related U.S. Application Data
(63) Continuation of application No. PCT/CN2009/070044, filed on Jan. 6, 2009.

(30) Foreign Application Priority Data
Jan. 7, 2008 (CN) 200810065163.2

(51) Int. Cl. H04W 72/12; H04W 52/02

(52) U.S. Cl. 370/311; 370/329

(57) ABSTRACT

A wireless system sleep method, a terminal and a base station are disclosed herein. The method includes the following steps: determining, by a Base Station, an availability interval and an unavailability interval of a sleep mode for a terminal, where the availability interval and the unavailability interval are both in subframes; and scheduling, by the BS, the availability interval and the unavailability interval for the terminal. The present invention is applicable to the wireless communication field.

This application is a continuation of co-pending International Application No. PCT/CN2009/070044, filed on Jan. 6, 2009, which designated the United States and was not published in English, and which claims priority to Chinese Application No. 200810065163.2, filed on Jan. 7, 2008, both of which applications are incorporated herein by reference.

### TECHNICAL FIELD

The present invention relates to the field of communications technologies, and, in particular embodiments, to a terminal apparatus and a sleep method of a wireless system.

### BACKGROUND

Institute of Electrical and Electronics Engineers (IEEE) develops data communications standards and other standards. The IEEE802 Committee is responsible for drawing up the Local Area Network (LAN) draft, and submitting the draft to American National Standard Institute (ANSI) for approval and standardization in America. The IEEE 802 specifies how a network adapter accesses a transmission medium (such as optical cable, twisted pair, and radio), and how to transmit data over transmission media; and defines means of creating, maintaining and clearing connections between network devices that transmit information.

IEEE 802.16e is a technology about an air interface of a Metropolitan Area Network (MAN), namely, a technology on the physical layer and the data link layer. A terminal in a normal state (no sleep) reads the preamble, broadcast message, Downlink Channel Descriptor (DCD), and Uplink Channel Descriptor (UCD) for every frame to accomplish synchronization and understand the uplink and downlink assignment, and communicate with a Base Station (BS) normally. All downlink and uplink resources are scheduled and assigned by the BS through an internal downlink scheduler and an uplink scheduler respectively, and downlink messages (downlink resources assignment message and uplink resources assignment message) are sent to each terminal to notify the terminal to perform the corresponding operations at the scheduled time. The downlink part is the part sent by the BS, and the uplink part is the part sent by the terminal. The 802.16 specifies a sleep method to reduce the power consumption of the terminal, and reduce occupation of air interface resources of the serving BS. The terminal based on the sleep method involves two intervals: availability interval, and unavailability interval. In the availability interval, like the normal state, no communication is performed between the BS and the terminal, but the terminal reads the preamble, broadcast messages, DCD, and UCD for every frame to accomplish synchronization and understand the uplink and downlink assignment. Currently, in the IEEE 802.16e, the UL-MAP of the first frame is responsible for assigning the uplink resources of the second frame.

The IEEE802.16e defines a sleep method performed in the unit of frame. That is, both availability interval and unavailability interval of sleep mode are measured in frames. FIG. 1 shows a 2-frame availability interval and a 2-frame unavailability interval. The first uplink subframe of every availability interval is unavailable to the terminal that uses this sleep mode. A 2-frame availability interval is enough for completing one uplink-downlink interaction. In FIG. 1, the dotted line represents a resources assignment relation. FIG. 2 shows a 1-frame availability interval and a 1-frame unavailability interval. The assignment of the uplink subframe depends on the message of the downlink subframe of the previous frame. For lack of a valid uplink assignment message, a terminal in the sleep mode is completely unable to use the uplink subframe in the availability interval.

For an IEEE 802.16e system, the availability interval and the unavailability interval in the sleep mode are measured in frames. Consequently, the terminal in the sleep mode is unable to send data in the first uplink subframe of the availability interval. When the availability interval is 2 frames, only one uplink-downlink interaction can be performed. Meanwhile, the terminal has wasted the uplink transmission opportunity. When the availability interval is 1 frame, for lack of uplink transmission, the uplink-downlink interaction is impossible.

### SUMMARY OF THE INVENTION

A wireless system sleep method is provided in an embodiment of the present invention. A BS determines an availability interval and an unavailability interval of a sleep mode for a terminal. The availability interval and the unavailability interval are both in subframes. The BS schedules the availability interval and the unavailability interval for the terminal.

A terminal is provided in another embodiment of the present invention. A sleep parameter obtaining module is configured to obtain an availability interval and an unavailability interval of a sleep mode determined by the BS according to a resources assignment relation. The availability interval and the availability interval are both in subframes. A sleep module is configured to sleep in subframes according to the availability interval and the unavailability interval obtained by the sleep parameter obtaining module.

A base station is further provided. The base station includes a first means for determining an availability interval and an unavailability interval for a terminal. The availability interval and the unavailability interval are both in subframes. A second means is coupled to the first means for scheduling the availability interval and the unavailability for the terminal.

In embodiments of the present invention, the availability interval and the unavailability interval of the uplink and downlink subframes are adjusted in subframes. Therefore, the terminal in the sleep mode can send data in the first uplink subframe of the availability interval. In the case that the length of the availability interval is one frame, an uplink-downlink interaction can be completed within two frames, and thus Quality of Service (QoS) of the relevant service is improved.

### BRIEF DESCRIPTION OF THE DRAWINGS

FIG. 1 shows a sleep method with a 2-frame availability interval in IEEE 802.16e in the prior art;

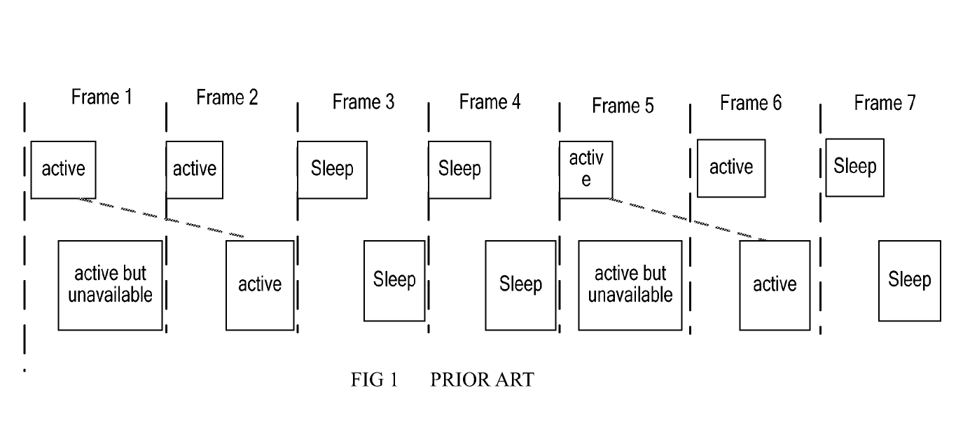

FIG. 2 shows a sleep method with a 1-frame availability interval in IEEE 802.16e in the prior art;

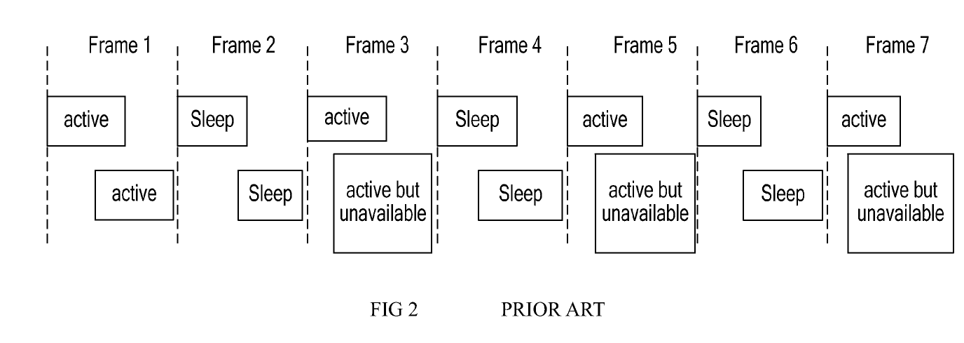

FIG. 3 shows a sleep method with a 2-frame availability interval in a TDD system in a first embodiment of the present invention;

FIG. 4 shows a sleep method with a 1-frame availability interval in a TDD system in a second embodiment of the present invention;

FIG. 5 shows a sleep method with a 2-frame availability interval in an FDD system in a third embodiment of the present invention; and

FIG. 6 shows a terminal in an embodiment of the present invention.

### DETAILED DESCRIPTION OF ILLUSTRATIVE EMBODIMENTS

The embodiments of the present invention disclose a sleep method of a wireless system to sleep in subframes. Evidently, the embodiments described herein are only part of, rather than all of, the embodiments of the present invention. Additionally, all other embodiments, which can be derived by those skilled in the art from the embodiments given herein without any creative efforts, fall within the scope of the present invention.

A wireless system sleep method is provided in an embodiment of the present invention. In this embodiment, a terminal sleeps in subframes, where a start frame for sleep-mode uplink subframes is different from a start frame for sleep-mode downlink subframes. A BS determines availability interval and unavailability interval of the downlink subframes and the uplink subframes according to a resources assignment relation.

Although the following takes the sleep method of a terminal as an example, embodiments of the present invention are also applicable to sleep of other devices such as mobile stations and test devices.

### A First Embodiment

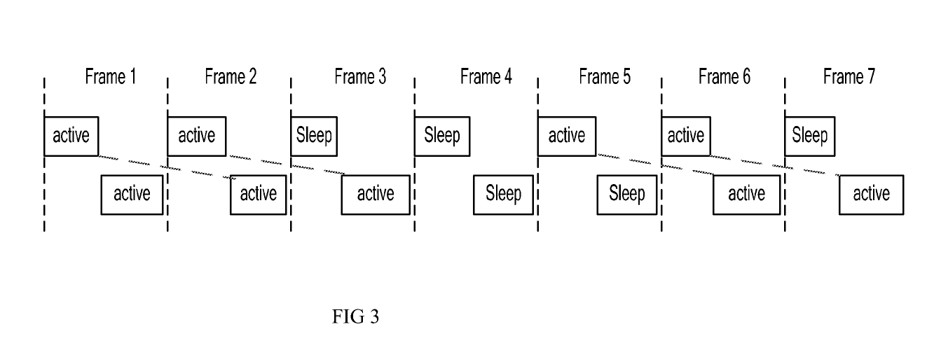

A first embodiment deals with a sleep mode in a Time Division Duplex (TDD) system, where the availability interval of sleep mode is two frames and the unavailability interval of sleep mode is also two frames, as shown in FIG. 3.

The sleep mode is in subframes. The downlink subframe of the third frame is in the sleep mode, and the uplink subframe of the fourth frame is in the sleep mode. Availability interval and unavailability are configured for the downlink subframe and the uplink subframe respectively according to the resource assignment relation. The first uplink subframe of the availability interval is combined with the downlink subframe of the previous frame to form an uplink-downlink logical resources pair. The downlink subframe of the third frame is located in the unavailability interval, and the uplink subframe of the third frame is located in the availability interval. The downlink subframe and the uplink subframe of the fourth frame are located in the unavailability interval. The downlink subframe of the fifth frame is located in the availability interval, and the uplink subframe of the fifth frame is located in the unavailability interval. By analogy, the downlink subframes of the first frame and the second frame are located in the availability interval, the downlink subframes of the third frame and the fourth frame are located in the unavailability interval, and the downlink subframes of the fifth frame and the sixth frame are located in the availability interval. The uplink subframes of the second frame and the third frame are located in the availability interval, the uplink subframes of the fourth frame and the fifth frame are located in the unavailability interval, and the uplink subframes of the sixth frame and the seventh frame are located in the availability interval. The unavailability interval or availability interval of subsequent subframes follows this regularity.

When the terminal is in the sleep mode, the BS negotiates with the terminal to determine sleep parameters. Sleep parameters include start frame number used in the sleep method, length of the availability interval, and length of the unavailability interval. The start frame number for the downlink subframe is set to be the third frame, and the start frame number for the uplink subframe is set to be the fourth frame. The availability interval is duration of two downlink subframes and two uplink subframes, and the unavailability interval is duration of two downlink subframes and two uplink subframes. The downlink scheduler schedules to send downlink data to the terminal at frame 4N+1 and frame 4N+2, and the uplink scheduler schedules the terminal to send uplink data at frame 4N+2 and frame 4N+3, where N is an integer not less than 1. The assignment of the uplink subframe depends on the message in the downlink subframe of the previous frame. Therefore, a terminal in the unavailability interval can use the first uplink subframe of the availability interval, for example, uplink subframe in frame 6. For the terminal, the waste of the uplink subframe transmission opportunity is avoided. The dotted line in FIG. 3 indicates the resources assignment relation. The resources assignment relation refers to a pre-agreed mapping relation between a downlink subframe and the uplink subframe specified by the resources assignment information in this downlink subframe. A typical resources assignment is that the downlink subframe of a frame assigns downlink resources of this frame and uplink resources of the next frame.

### A Second Embodiment

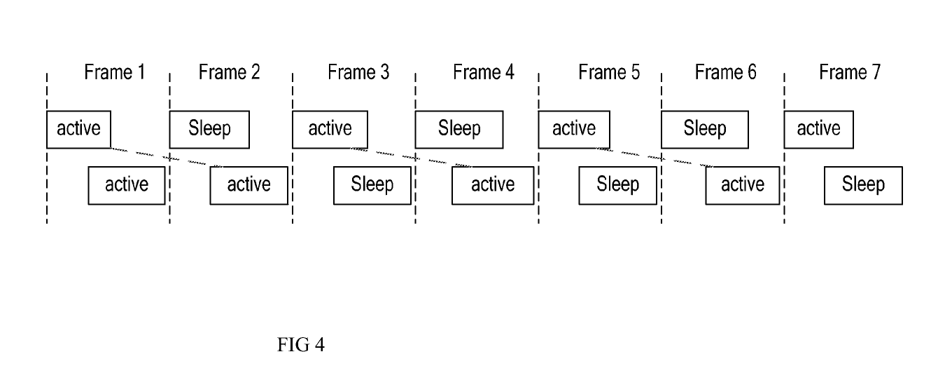

The second embodiment deals with a sleep mode in a TDD system, where the availability interval is 1 frame and the unavailability interval is 1 frame too, as shown in FIG. 4.

The sleep mode is in subframes, and the BS negotiates with the terminal to determine sleep parameters. Sleep parameters include: start frame number used in the sleep method, length of the availability interval, and length of the unavailability interval. The start frame number of the downlink subframe is set to be the second frame, and the start frame number of the uplink subframe is set to be the third frame. The availability interval is duration of one downlink subframe and one uplink subframe, and the unavailability interval is duration of one downlink subframe and one uplink subframe. The downlink subframe enters the sleep mode in the second frame, and the uplink subframe enters the sleep mode in the third frame. The availability interval and unavailability interval of the downlink subframes and the uplink subframes are configured respectively according to a resources assignment relation. The downlink subframe of the second frame is located in the unavailability interval, the downlink subframe of the third frame is located in the availability interval, and the downlink subframe of the fourth frame is located in the unavailability interval, and so on. The uplink subframe of the third frame is located in the unavailability interval, the uplink subframe of the fourth frame is located in the availability interval, the uplink subframe of the fifth frame is located in the unavailability interval, and the uplink subframe of the sixth frame is located in the availability interval, and so on.

The assignment of an uplink subframe depends on the message of a downlink subframe of the previous frame. Therefore, the uplink subframe of the fourth frame is assigned by the downlink subframe of the third frame. Because the downlink subframe of the third frame is located in the availability interval, an uplink-downlink interaction can be completed.

### A Third Embodiment

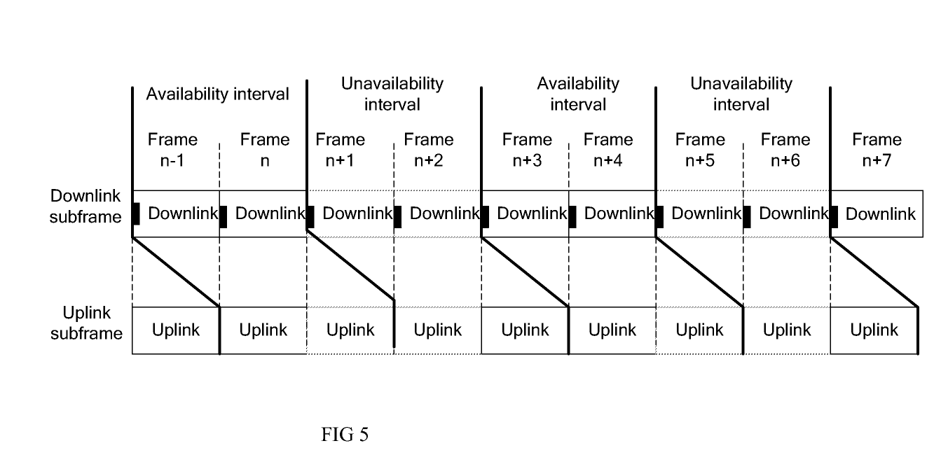

A third embodiment deals with a sleep mode in an IEEE 802.16e Frequency Division Duplex (FDD) system, where the availability interval is two frames and the unavailability interval is also two frames, as shown in FIG. 5.

The sleep mode is in subframes, and the BS negotiates with the terminal to determine sleep parameters. Sleep parameters include: start frame number used in the sleep method, length of the availability interval, and length of the unavailability interval. The start frame number for the downlink subframe is set to be the second frame, and the start frame number for the uplink subframe is set to be the third frame. The availability interval is duration of two downlink subframes and two uplink subframes, and the unavailability interval is duration of two downlink subframes and two uplink subframes. The downlink subframe enters the sleep mode in the second frame, and the uplink subframe enters the sleep mode in the third frame. The availability interval is alternated with the unavailability interval at an interval of 2 frames. The availability interval and unavailability interval of the downlink subframes and the uplink subframes are configured respectively according to a resources assignment relation. The downlink subframes of the first frame and the second frame are located in the availability interval, the downlink subframes of the third frame and the fourth frame are located in the unavailability interval, and the downlink subframes of the fifth frame and the sixth frame are located in the availability interval. The uplink subframes of the second frame and the third frame are located in the availability interval, the uplink subframes of the fourth frame and the fifth frame are located in the unavailability interval, and the uplink subframes of the sixth frame and the seventh frame are located in the availability interval. The unavailability interval or availability interval of subsequent subframes follows this regularity.

The assignment of an uplink subframe depends on the message of a downlink subframe of the previous frame. For example, the uplink subframe of the second frame is assigned by the downlink subframe of the first frame. Because the downlink subframe of the first frame is located in the availability interval, the terminal in the sleep mode can use the first uplink subframe of the availability interval. For the terminal, the waste of the uplink subframe transmission opportunity is avoided. The dotted line in FIG. 5 indicates the resources assignment relation.

The uplink subframes and the downlink subframes mentioned above may be located in the same band or different bands, for example, in a TDD system or an FDD system. Parameters of the availability interval and the unavailability interval are configured respectively according to the resources assignment relation.

In the solution provided in this embodiment, the terminal in the unavailability interval can send data in the first uplink subframe of the availability interval, and an uplink-downlink interaction can be completed in the case that the length of the availability interval is one frame.

The embodiments of the present invention are applicable to sleep of terminals, mobile stations, test devices, and so on.

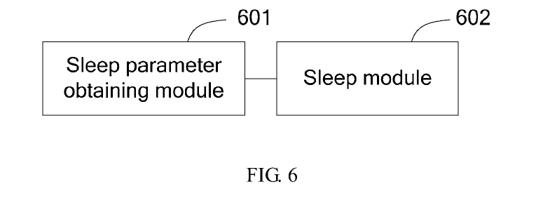

A terminal is provided in another embodiment of the present invention. As shown in FIG. 6, the terminal includes a sleep parameter obtaining module 601 that is configured to obtain availability interval and unavailability interval determined by the BS according to a resources assignment relation. A sleep module 602 is configured to sleep in subframes according to the availability interval and the unavailability interval obtained by the sleep parameter obtaining module 601.

On the basis of the foregoing embodiment, the first uplink subframe of the availability interval obtained by the sleep parameter obtaining module is combined with the downlink subframe of the previous frame into an uplink-downlink logical resources pair.

With the terminal provided in this embodiment, sleep occurs in subframes. The terminal in the sleep mode can send data in the first uplink subframe of the availability interval. In the case that the length of the availability interval is one frame, an uplink-downlink interaction can be completed within two frames, and thus QoS of the relevant service is improved.

The above descriptions are merely some exemplary embodiments of the present invention, but not intended to limit the scope of the present invention. Any modifications, variations or replacement that can be easily derived by those skilled in the art should fall within the scope of the present invention. Therefore, the protection scope of the present invention is subject to the appended claims.

What is claimed is:

1. A wireless system sleep method, comprising:
determining, by a Base Station (BS), an availability interval and an unavailability interval of a sleep mode for a terminal, wherein the availability interval and the unavailability interval are both in subframes; and
scheduling, by the BS, the availability interval and the unavailability interval for the terminal.

2. The wireless system sleep method of claim 1, wherein an uplink subframe in the availability interval is combined with a downlink subframe of a corresponding previous frame in the same availability interval to form an uplink-downlink logical resources pair.

3. The wireless system sleep method of claim 2, wherein the availability interval and the unavailability interval are determined respectively according to a resources assignment relation.

4. The wireless system sleep method of claim 1, wherein determining the availability interval comprises determining the availability interval according to a resource assignment relation.

5. The wireless system sleep method of claim 4, wherein the resources assignment relation comprises a pre-agreed mapping relation between a downlink subframe and an uplink subframe specified by resource assignment information in the downlink subframe.

6. The wireless system sleep method of claim 4, wherein assignment of an uplink subframe in the availability interval depends on a message in a downlink subframe in the availability interval.

7. The wireless system sleep method of claim 4, further comprising the BS negotiating with the terminal to determine sleep parameters for the terminal.

8. The wireless system sleep method of claim 7, wherein the sleep parameters include a start frame number for a downlink subframe and a start frame number for an uplink subframe, wherein the start frame number for a downlink subframe is different than the start frame number for an uplink subframe.

9. The wireless system sleep method of claim 1, wherein duration of the availability interval is four subframes and a frame comprises one uplink subframe and one downlink subframe; and
wherein the availability interval covers a downlink subframe of a first frame, an uplink subframe of a second frame following the first frame, a downlink subframe of the second frame, an uplink subframe of a third frame following the second frame, and the uplink subframe of the first frame is in the unavailability interval.

10. The wireless system sleep method of claim 1, wherein
duration of the availability interval is two subframes and wherein a frame comprises one uplink subframe and one downlink subframe; and
the availability interval covers a downlink subframe of a first frame, an uplink subframe of a second frame following the first frame, and the uplink subframe of the first frame is in the unavailability interval.

11. A terminal, comprising:
a sleep parameter obtaining module configured to obtain an availability interval and an unavailability interval of a sleep mode determined by a Base Station (BS) according to a resources assignment relation, wherein the availability interval and the availability are both in subframes; and
a sleep module configured to sleep in subframes according to the availability interval and the unavailability interval obtained by the sleep parameter obtaining module.

12. The terminal of claim 11, wherein a first uplink subframe in the availability interval obtained by the sleep parameter obtaining module is combined with a downlink subframe in a corresponding previous frame to form an uplink-downlink logical resources pair.

13. The terminal of claim 11, wherein the resources assignment relation is a pre-agreed mapping relation between a downlink subframe and an uplink subframe specified by resource assignment information in the downlink subframe.

14. The terminal of claim 11, wherein assignment of an uplink subframe in the availability interval depends on a message in a downlink subframe in the availability interval.

15. A base station comprising:
means for determining an availability interval and an unavailability interval for a terminal, wherein the availability interval and the unavailability interval are both in subframes; and
means for scheduling the availability interval and the unavailability interval for the terminal, wherein the means for determining is coupled to the means for scheduling.

16. The base station of claim 15, further comprising means for negotiating with the terminal to determine sleep parameters, wherein the means for negotiating is coupled to the means for determining.

17. The base station of claim 15, wherein the means for determining is configured to determine the availability interval and the unavailability interval for the terminal according to a resources assignment relation.

18. The base station of claim 17, wherein the resources assignment relation comprises a pre-agreed mapping relation between a downlink subframe and an uplink subframe specified by resource assignment information in the downlink subframe.

19. The base station of claim 15, wherein assignment of an uplink subframe in the availability interval depends on a message in a downlink subframe in the availability interval.
